(19) United States
(12) Patent Application Publication
(10) Pub. No.: US 2023/0194813 A1
(43) Pub. Date: Jun. 22, 2023

(54) INDOOR/OUTDOOR MICRO-DUCT CABLES

(71) Applicant: AFL Telecommunications LLC, Duncan, SC (US)

(72) Inventor: Jarrett Shinoski, Greenville, SC (US)

(21) Appl. No.: 17/925,381

(22) PCT Filed: May 7, 2021
(86) PCT No.: PCT/US2021/031253

§ 371 Date: Nov. 15, 2022

Related U.S. Application Data
(60) Provisional application No. 63/025,456, filed on May 15, 2020.

(51) Int. Cl. G02B 6/44

(52) U.S. Cl. CPC G02B 6/4436; G02B 6/4434

(57) ABSTRACT

An indoor/outdoor micro-duct cable includes a central strength member, and six outer members surrounding the central strength member in a 6@1 configuration. At least one of the outer members is a buffer tube. A plurality of optical fibers are disposed within the buffer tube. The others of the six outer members are filler rods. The cable further includes an outer jacket surrounding the six outer members, the outer jacket having a diameter of less than 9 millimeters and a thickness of less than 1.7 millimeters. The outer jacket is formed from a flame retardant material. The filler rods are formed from a flame retardant material different from the flame retardant material of the outer jacket.

### CROSS-REFERENCE TO RELATED APPLICATIONS

The present application claims priority to U.S. Provisional Patent Application Ser. No. 63/025,456 filed on May 15, 2020, the disclosure of which is incorporated by reference herein in its entirety.

### FIELD

The present disclosure relates generally to cables, and more particularly to indoor/outdoor micro-duct cables having improved flame resistance properties while also having higher densities and smaller outer diameters.

### BACKGROUND

Optical-fiber nonconductive general-purpose (OFNG) cable is suitable for general-purpose use but cannot be used in riser (OFNR) or plenum (OFNP) applications. Plenum is the highest of the flame resistance ratings, followed by Riser, and then General. Additionally, to be categorized as a low-smoke cable, one test that such cables must pass is Test Procedure UL 1685, “Vertical-Tray Fire-Propagation and Smoke-Release Test for Electrical and Optical-Fire Cables,” includes a flame test equivalent to the UL-1581 vertical-tray flame test, as well as measurement and pass/fail criteria for smoke density. Cables meeting this requirement are designated Type OFNG-LS or OFN-LS (UL); the “LS” indicates that the cable generates an acceptable low-smoke density when flame-tested.

In many applications, such as mass transit metro rail communications networks, fiber to the home applications, campus applications, and long-haul network applications, cable which are flame resistant and which can be “blown” or “jetted” long distances are desired. Some presently known cables, however, cannot meet current customer requirements. For example, some cables include an outer jacket made of Flame Retardant Polyethylene (FRPE) also known as Low Smoke Zero Halogen (LSZH). This is a great flame-retardant outer jacket material choice in that it was very durable, it was UV resistant, and had good burn characteristics. However, some such cable have certain issues.

For example, some such cables cannot not be manufactured in fiber counts lower than 144-fibers. Fiber counts below 144 require filler rods and the filler rod currently utilized are not compatible with the outer jacket. The filler rods and the outer jacket were made of the same FRPE material. When manufactured, the outer jacket would bond to the filler rods and the filler rods would bond to one another, creating a cable that was not accessible by the crafts person.

Further, some such cables cannot meet the blown distance requirements that customers require. FRPE is inherently heavy as it is a material with a multitude of fillers which gives its flame retardant properties. In metro applications, for example, such resulting short blowing distances required personnel to go out on the train tracks to splice cables together, which causes safety concerns. Accordingly, a requirement has arisen for cable which is smaller in diameter, lighter, and slicker in order to meet the blowing distances required by the customer.

Accordingly, improved indoor/outdoor micro-duct cables having improved flame resistance properties while also having higher densities and smaller outer diameters are desired in the art. Additionally, such cable which can be blown long distances would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, an indoor/outdoor micro-duct cable is provided. The cable includes a central strength member, and six outer members surrounding the central strength member in a 6@1 configuration. At least one of the outer members is a buffer tube. A plurality of optical fibers are disposed within the buffer tube. The others of the six outer members are filler rods. The cable further includes an outer jacket surrounding the six outer members, the outer jacket having a diameter of between 8.5 millimeters and 9 millimeters and a thickness of between 1.6 and 1.7 millimeter. The outer jacket is formed from a low smoke zero halogen material. The filler rods are formed from polypropylene.

In accordance with another embodiment, an indoor/outdoor micro-duct cable is provided. The cable includes a central strength member, and six outer members surrounding the central strength member in a 6@1 configuration. At least one of the outer members is a buffer tube. A plurality of optical fibers are disposed within the buffer tube. The others of the six outer members are filler rods. The cable further includes an outer jacket surrounding the six outer members, the outer jacket having a diameter of less than 9 millimeters and a thickness of less than 1.7 millimeters. The outer jacket is formed from a flame retardant material. The filler rods are formed from a flame retardant material different from the flame retardant material of the outer jacket.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a cross-sectional view of a cable in accordance with embodiments of the present disclosure;

FIG. 2 is a cross-sectional view of a cable in accordance with other embodiments of the present disclosure;

FIG. 3 is a cross-sectional view of a cable in accordance with other embodiments of the present disclosure; and

FIG. 4 is a cross-sectional view of a cable in accordance with other embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, cables in accordance with the present disclosure are improved indoor/outdoor micro-duct cables which have improved flame resistance properties while also having higher densities and smaller outer diameters relative to known cables. Additionally, such cable can advantageously be blown long distances relative to known cables.

Specifically, cables in accordance with the present disclosure provide an advantage over prior art cables in that the number of fibers can be maximized within a small cable package. This is advantageous for blown installations. The cable construction advantageously allows for air-jetting into single or bundled micro-duct pathways, because it has such a small diameter and light weight. This cable can be jetted very long distances. The cable offers network designers a variety of pathway and labor cost-savings opportunities when compared to traditional loose tube cables. Because such cables have advantageous flame resistance characteristics, such as in exemplary embodiments an OFNG-LS rating, they can be installed into areas where the designer would typically have to transition from a traditional outside plant loose tube cable to an indoor or indoor/outdoor flame rated cable. Use of cables in accordance with the present disclosure prevents costly junction points and a potential for splice box issues. Cables in accordance with the present disclosure are ideally suited for metro-loop, FTTH, Campus backbone, and long-haul network applications.

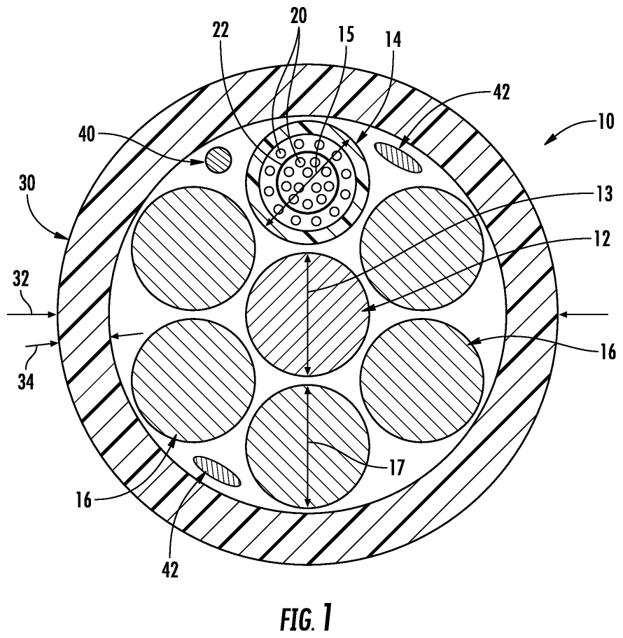

Referring now to the FIG. 1 through 4, embodiments of indoor/outdoor micro-duct cables 10 in accordance with the present disclosure are provided. A cable 10 may include, for example, a central strength member 12. Central strength member 12 may, for example, be formed from a fiber reinforced polymer material such as a fiberglass reinforced polymer material. In exemplary embodiments, central strength member 12 may have an outer diameter 13 of less than 2 millimeters, such as between 1.8 millimeters and 2 millimeters.

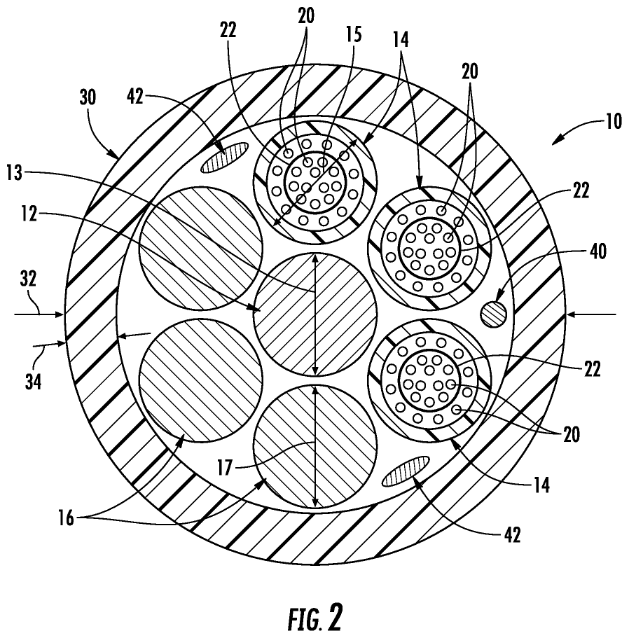

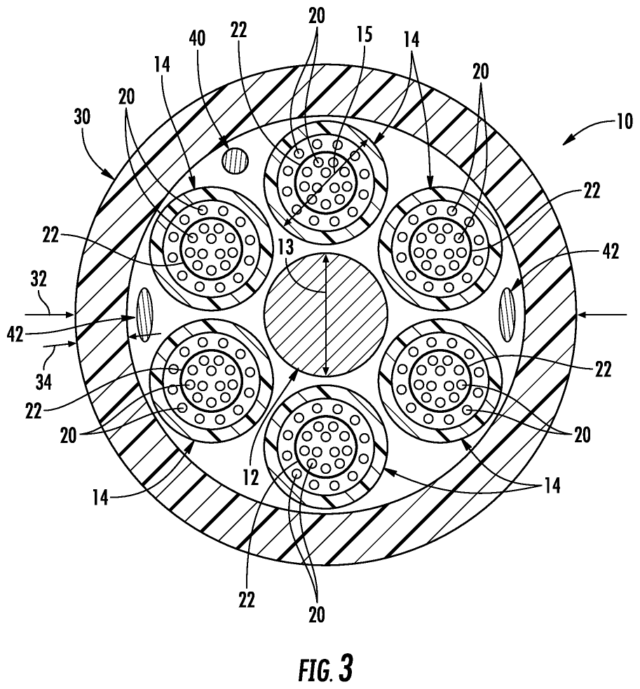

Six outer members may surround the central strength member 12 in a 6@1 configuration as illustrated. At least one outer member may be a buffer tube 14, and the others of the six outer members may be filler rods 16. In some embodiments as illustrated in FIG. 1, the six outer members may include one buffer tube 14 and five filler rods 16. In other embodiments as illustrated in FIG. 2, the six outer members may include two, three, four, or five buffer tubes 14 and four, three, two, or one filler rods 16. In other embodiments as illustrated in FIG. 3, the six outer members may include six buffer tubes 14 and zero filler rods 16.

In exemplary embodiments, buffer tubes 14 may be formed from a polybutylene terephthalate (PBT) material. Further, in exemplary embodiments, buffer tubes 14 may each have an outer diameter 15 of less than 2 millimeters, such as between 1.8 millimeters and 2 millimeters.

A plurality of optical fibers 20 may be disposed within each buffer tube 14. For example, in exemplary embodiments, at least 12 optical fibers 20 may be disposed within each buffer tube 14, such as in some embodiments 24 optical fibers 20. Further, in exemplary embodiments, each of the plurality of optical fibers has a nominal outer diameter of less than 250 microns. For example, in some embodiments, each of the plurality of optical fibers has a nominal outer diameter of 200 microns. In exemplary embodiments, each buffer tube 14 additionally is gel-filled.

In some embodiments, the plurality of optical fibers 20 are split into two bundles of optical fibers 20, such as in exemplary embodiments two 12 fiber bundles 20. In some embodiments, one or both bundles are formed as a ribbon, such as in some embodiments an intermittently-bonded optical fiber ribbon. In other embodiments, one or both bundles are formed from loose optical fibers. In some embodiments, both bundles are separately bound, such as by identification thread(s) 22. In other embodiments, neither bundle is bound. In exemplary embodiments as illustrated, one bundle is bound by identification thread(s) 22, and the other bundle is loose such that the optical fibers 20 of the loose bundle float around the optical fibers 20 of the bound bundle. Such configurations of the optical fibers 20 advantageously allow for space savings, thus facilitating higher optical fiber densities.

Cable 10 may further include an outer jacket 30. Outer jacket 30 may surround the six outer members, and in some embodiments may contact the six outer members. Additionally or alternatively, other cable components such as ripcords 40 and/or binders 42 may be disposed between the outer jacket 30 and six outer members. Because the cable has a 6@1 configuration, there is no additional layer of members (e.g. buffer tubes or filler rods) between the outer members and the outer jacket 30.

Outer jacket 30 may be formed from a flame retardant material. A flame retardant material in accordance with the present disclosure is a material that allows the cable 10 to pass Test Procedure UL 1685 in accordance with the UL Standard for Vertical-Tray Fire-Propagation and Smoke-Release Test for Electrical and Optical-Fiber Cables as of Jul. 7, 2015. In some embodiments, such material may be a material that allows the cable to have an OFNG-LS rating, such as due to passing the UL 1685 burn test with limited smoke release. For example, in exemplary embodiments, outer jacket 30 may be formed from a low smoke zero halogen (LSZH) material, such as a cross-linked polyethylene or other suitable material. In other exemplary embodiments, outer jacket 30 may be formed from polyvinyl difluoride (PVDF) or polyvinylchloride (PVC).

In exemplary embodiments, the outer jacket 30 may have an outer diameter 32 of less than 9 millimeters. Additionally, the outer jacket 30 may have a thickness 34 of less than 1.7 millimeters. For example, in some embodiments, such as the embodiments illustrated in FIGS. 1 through 3, the outer jacket 30 may have an outer diameter 32 of between 8.5 millimeters and 9 millimeters. Additionally, the outer jacket 30 may have a thickness of between 1.6 millimeters and 1.7 millimeters. In exemplary embodiments, such outer jackets 30 may be formed from a LSZH material.

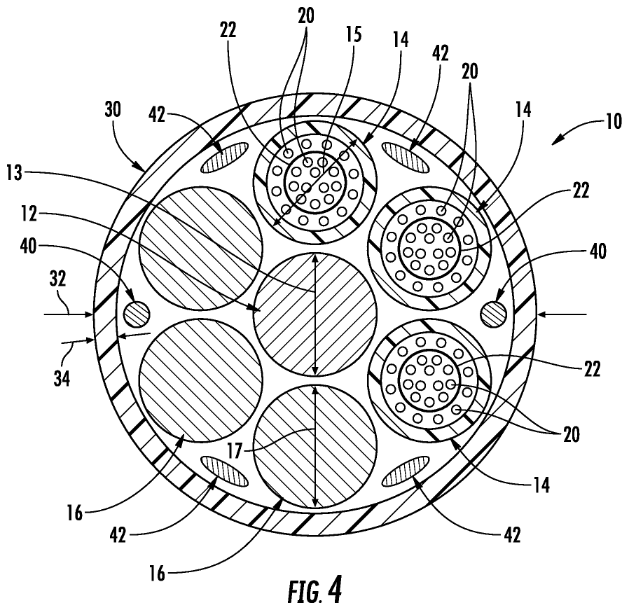

In alternative exemplary embodiments, such as the embodiments illustrated in FIG. 4, the outer jacket 30 may have an outer diameter 32 of between 6.5 millimeters and 6.9 millimeters. Additionally, the outer jacket 30 may have a thickness of between 0.5 millimeters and 0.7 millimeters. In exemplary embodiments, such outer jackets 30 may be formed from a PVDF material.

As discussed above, the outer members may include one or more filler rods 16. Each filler rod 16 may be formed from a flame retardant material that is different from the flame retardant material of the outer jacket 30. For example, in exemplary embodiments, filler rods 16 may be formed from polypropylene. In alternative embodiments, filler rods 16 may be formed from polyetheylene. Polypropylene filler rods 16 are particularly advantageous when a LSZH outer jacket 30 is utilized. The difference in materials of the filler rods 16 from the outer jacket 30 advantageously reduces or prevents the risk of bonding between the filler rods 16 and outer jacket 30 in high temperature applications.

In exemplary embodiments, filler rods 16 are solid rods 16. Alternatively, filler rods 16 are foamed rods (such as for example, closed cell foamed rods). Notably, filler rods 16 are not tubes which include central openings, but rather are rods as shown and described herein. In exemplary embodiments, filler rods 16 may each have an outer diameter 17 of less than 2 millimeters, such as between 1.8 millimeters and 2 millimeters.

As discussed, in exemplary embodiments, cables 10 in accordance with the present disclosure have an OFNG-LS rating. Further, in exemplary embodiments, cables 10 in accordance with the present disclosure pass Test Procedure UL 1685 in accordance with the UL Standard for Vertical-Tray Fire-Propagation and Smoke-Release Test for Electrical and Optical-Fiber Cables as of Jul. 7, 2015.

Still further, cables 10 in accordance with the present disclosure may qualify under one or more of the following standards: Telcordia GR-20-CORE as of July 2013; ICEA S-104-696 as of Aug. 25, 2016; CSA 22.2 (FT4) as of January 2020; NFPA 130 as of Feb. 20, 2020; and/or TIA 598-D as of Jul. 9, 2014.

Further aspects of the invention are provided by one or more of the following embodiments:

An indoor/outdoor micro-duct cable having a central strength member, and six outer members surrounding the central strength member in a 6@1 configuration. At least one of the outer members is a buffer tube. A plurality of optical fibers are disposed within the buffer tube. The others of the six outer members are filler rods. The cable further includes an outer jacket surrounding the six outer members, the outer jacket having a diameter of less than 9 millimeters and a thickness of less than 1.7 millimeters. The outer jacket is formed from a flame retardant material. The filler rods are formed from a flame retardant material different from the flame retardant material of the outer jacket.

A cable of any one or more of the embodiments described herein, wherein the outer jacket is formed from a low smoke zero halogen material or a polyvinylidene fluoride material.

A cable of any one or more of the embodiments described herein, wherein the filler rods are formed from polypropylene.

A cable of any one or more of the embodiments described herein, wherein the plurality of optical fibers is 24 optical fibers split into two 12 fiber bundles, wherein one of the two 12 fiber bundles is bound, and wherein the other of the two 12 fibers bundles is loose.

A cable of any one or more of the embodiments described herein, wherein the outer jacket is formed from a low smoke zero halogen material and has a thickness of between 1.6 and 1.7 millimeters.

A cable of any one or more of the embodiments described herein, wherein the outer jacket has a thickness of between 1.6 millimeters and 1.7 millimeters.

A cable of any one or more of the embodiments described herein, wherein the outer jacket has a diameter of between 8.5 millimeters and 9 millimeters.

A cable of any one or more of the embodiments described herein, wherein the outer jacket is formed from a polyvinylidene fluoride material.

A cable of any one or more of the embodiments described herein, wherein the outer jacket has a thickness of between 0.5 millimeters and 0.7 millimeters.

A cable of any one or more of the embodiments described herein, wherein the outer jacket has a diameter of between 6.5 millimeters and 6.9 millimeters.

A cable of any one or more of the embodiments described herein, wherein each of the plurality of optical fibers has a nominal outer diameter of less than 250 microns.

A cable of any one or more of the embodiments described herein, wherein each of the plurality of optical fibers has a nominal outer diameter of 200 microns.

A cable of any one or more of the embodiments described herein, wherein the central strength member is a fiber reinforced polymer rod.

A cable of any one or more of the embodiments described herein, wherein the cable has an OFNG-LS rating.

A cable of any one or more of the embodiments described herein, wherein the cable passes Test Procedure UL 1685 in accordance with the UL Standard for Vertical-Tray Fire-Propagation and Smoke-Release Test for Electrical and Optical-Fiber Cables as of Jul. 7, 2015.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An indoor/outdoor micro-duct cable, the cable comprising:
a central strength member;
six outer members surrounding the central strength member in a 6@1 configuration, wherein at least one of the outer members is a buffer tube, wherein a plurality of optical fibers are disposed within the buffer tube, and wherein the others of the six outer members are filler rods;
an outer jacket surrounding the six outer members, the outer jacket having a diameter of between 8.5 millimeters and 9 millimeters and a thickness of between 1.6 millimeters and 1.7 millimeters,
wherein the outer jacket is formed from a low smoke zero halogen material, and
wherein the filler rods are formed from polypropylene.

2. The cable of claim 1 wherein the plurality of optical fibers is 24 optical fibers split into two 12 fiber bundles, wherein one of the two 12 fiber bundles is bound, and wherein the other of the two 12 fibers bundles is loose.

3. The cable of claim 1, wherein each of the plurality of optical fibers has a nominal outer diameter of less than 250 microns.

4. The cable of claim 3, wherein each of the plurality of optical fibers has a nominal outer diameter of 200 microns.

5. The cable of claim 1, wherein the central strength member is a fiber reinforced polymer rod.

6. The cable of claim 1, wherein the cable has an OFNG-LS rating.

7. The cable of claim 1, wherein the cable passes Test Procedure UL 1685 in accordance with the UL Standard for Vertical-Tray Fire-Propagation and Smoke-Release Test for Electrical and Optical-Fiber Cables as of Jul. 7, 2015.

8. An indoor/outdoor micro-duct cable, the cable comprising:
a central strength member;
six outer members surrounding the central strength member in a 6@1 configuration, wherein at least one of the outer members is a buffer tube, wherein a plurality of optical fibers are disposed within the buffer tube, and wherein the others of the six outer members are filler rods; and
an outer jacket surrounding the six outer members, the outer jacket having a diameter of less than 9 millimeters and a thickness of less than 1.7 millimeters,
wherein the outer jacket is formed from a flame retardant material, and
wherein the filler rods are formed from a flame retardant material different from the flame retardant material of the outer jacket.

9. The cable of claim 8, wherein the outer jacket is formed from a low smoke zero halogen material or a polyvinylidene fluoride material.

10. The cable of claim 8, wherein the filler rods are formed from polypropylene.

11. The cable of claim 8, wherein the plurality of optical fibers is 24 optical fibers split into two 12 fiber bundles, wherein one of the two 12 fiber bundles is bound, and wherein the other of the two 12 fibers bundles is loose.

12. The cable of claim 8, wherein the outer jacket is formed from a low smoke zero halogen material and has a thickness of between 1.6 millimeters and 1.7 millimeters.

13. The cable of claim 12, wherein the outer jacket has a diameter of between 8.5 millimeters and 9 millimeters.

14. The cable of claim 8, wherein the outer jacket is formed from a polyvinylidene fluoride material and has a thickness of between 0.5 millimeters and 0.7 millimeters.

15. The cable of claim 14, wherein the outer jacket has a diameter of between 6.5 millimeters and 6.9 millimeters.

16. The cable of claim 8, wherein each of the plurality of optical fibers has a nominal outer diameter of less than 250 microns.

17. The cable of claim 8, wherein the central strength member is a fiber reinforced polymer rod.

18. The cable of claim 8, wherein the cable has an OFNG-LS rating.

19. The cable of claim 8, wherein the cable passes Test Procedure UL 1685 in accordance with the UL Standard for Vertical-Tray Fire-Propagation and Smoke-Release Test for Electrical and Optical-Fiber Cables as of Jul. 7, 2015.
